(19) United States
(12) Patent Application Publication
(10) Pub. No.: US 2026/0237579 A1
(43) Pub. Date: Aug. 13, 2026

(54) POWER CONTACTOR HAVING AN ELECTRIC ARC CLARIFICATION SCREEN, AND AIRCRAFT COMPRISING SUCH A POWER CONTACTOR

(71) Applicant: SAFRAN ELECTRICAL & POWER, Blagnac (FR)

(72) Inventor: Eric GUILLARD, Moissy-Cramayel (FR)

(21) Appl. No.: 19/130,411

(22) PCT Filed: Nov. 13, 2023
(86) PCT No.: PCT/FR2023/051777

§ 371 Date: May 15, 2025

(30) Foreign Application Priority Data
Nov. 21, 2022 (FR) 2212104

(51) Int. Cl. H01H 33/70; B64D 45/00

(52) U.S. Cl. CPC H01H 33/70; B64D 45/00; B64D 2221/00

(57) ABSTRACT

The power contactor include a fixed contact; a movable contact; and an electric insulating screen designed to move between a spaced position and a position interposed between the fixed contact and the movable contact in the remote position of the latter. It furthermore includes a return device designed to push the screen from its spaced position to its interposed position; and a fuse forming a mechanical stop that prevents the screen from leaving its spaced position, the fuse being designed to trip in order to allow the screen to leave its spaced position so as to reach its interposed position under the effect of the return device, under the effect of heat released by an electric arc that occurs between the contact.

### TECHNICAL FIELD OF THE INVENTION

The present invention relates to a power contactor with an electric arc clarification screen, as well as an aircraft comprising such a power contactor.

As is well known, a power contactor is an electrical device designed to selectively establish or interrupt the flow of a current, from a remote control, for example electrical or pneumatic.

### TECHNICAL BACKGROUND

The vertical take-off and landing aircraft (VTOL) and Conventional Take Off and Landing (CTOL) with electric or hybrid propulsion constitute a market with significant prospects and demand in intra-urban and inter-urban transport for goods or people.

The propulsion of these different platforms is provided by one or more electric motors, the number varying depending on the aircraft architecture. These electric propulsion systems use increasingly high levels of direct current.

The failure modes of these systems show that the occurrence of a series electric arc can have serious consequences for aircraft structures if it is not clarified (i.e., stopped).

However, an electric arc generally occurs between each pair of movable contact/fixed contact of a power contactor. If these electric arcs remain in place, they could cause a fire. This is why an arc blowing device is generally associated with the power contactor. Nevertheless, if the arc blow fails, the electric arc can cause a fire.

Furthermore, it is known to move an electrically insulating screen between the two fixed/movable contacts each time they are separated, see for example the international application published under number WO 1985 005218 A1. Inserting the screen between the two contacts causes the electric arc to disappear. However, a carbon path may appear and become stronger each time the screen is used, gradually rendering it inoperative.

It may therefore be desirable to provide a power contactor that allows at least some of the above problems and constraints to be overcome.

### SUMMARY OF THE INVENTION

A power contactor is therefore proposed comprising:
a fixed contact;
a movable contact designed to move relative to the fixed contact between a position in contact with the fixed contact to allow current to pass and a remote position from the fixed contact to prevent current from passing; and
an electrically insulating screen designed to move between a spaced apart position and a position interposed between the fixed contact and the movable contact in its remote position;
characterized by:
a return device designed to push the screen from its spaced apart position to its interposed position; and
a fuse forming a mechanical stop preventing the screen from leaving its spaced apart position, the fuse being designed to trip in order to allow the screen to leave its spaced apart position to reach its interposed position under the effect of the return device, under the effect of heat generated by an electric arc appearing between the fixed contact and the movable contact.

The invention may further comprise one or more of the following optional characteristics, in any technically possible combination.

Preferably, the power contactor further comprises:-another fixed contact; and another movable contact designed to move relative to the other fixed contact between a position in contact with the other fixed contact to allow current to pass and a remote position from the other fixed contact to prevent current from passing, the two movable contacts being fixed to each other so as to move at the same time.

Preferably also, the screen is in the form of a plate, preferably perpendicular to a closing direction in which the movable contact moves between its spaced apart position and its interposed position.

Preferably also, the screen further comprises a busbar to which the fixed contact is fixed, and the fuse is fixed to the busbar.

Preferably also, the fuse is in the form of a pin, preferably rising parallel to the closing direction.

Preferably also, the return device comprises a spring.

Preferably also, the spring is extended between a fixed point and the screen.

Preferably also, the power contactor further comprises a blowing device of an electric arc appearing between the fixed contact and the movable contact.

An aircraft comprising a contactor according to the invention is also proposed.

### BRIEF DESCRIPTION OF THE FIGURES

The invention will be better understood with the aid of the following description, which is given by way of example only and with reference to the accompanying drawings, in which:

FIG. 1 is a three-dimensional view of an example of a power contactor according to the invention,

FIG. 2 is a block diagram of an example of a method of operation of the power contactor of FIG. 1,

FIG. 3 is a view like that of FIG. 1, with electric arcs shown, and

FIG. 4 is a three-dimensional view of the power contactor of FIG. 1 after triggering of an electric arc clarification screen.

### DETAILED DESCRIPTION OF THE INVENTION

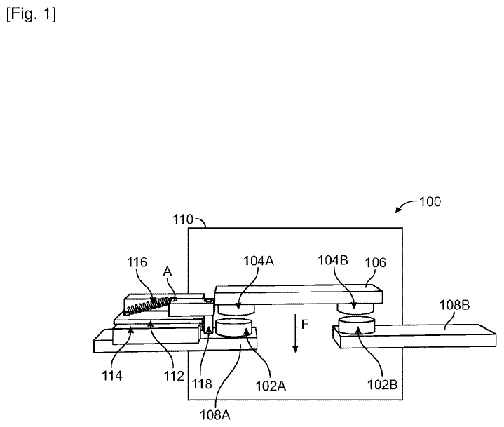

With reference to FIG. 1, an example of a power contactor 100 according to the invention will now be described.

The power contactor 100 comprises at least one pair of two contacts, one 102A, 102B being fixed and the other 104A, 104B being movable. The movable contact 104A, 104B is thus designed to move relative to the fixed contact 102A, 102B between a position in contact with the fixed contact 102A, 102B to allow current to pass and a remote position from the fixed contact 102A, 102B to prevent current from passing. The movement is, for example, in a straight line, following a closing direction F.

For example, the power contactor 100 is double-break, as in the example shown, and comprises two pairs of fixed 102A, 102B and movable 104A, 102B contacts. In this case, the two movable contacts 104A, 104B are fixed to each other so as to move at the same time. For example, the power contactor 100 comprises a movable busbar 106 having two ends where the two movable contacts 104A, 104B are respectively fixed. Thus, the two movable contacts 104A, 104B are designed to move at the same time, with the busbar 106, in the closing direction F to come into contact, substantially at the same time, with their associated fixed contact 102.

The power contactor 100 may further comprise, for each fixed contact 102A, 102B, a fixed busbar 108A, 108B to which this fixed contact 102A, 102B is fixed.

The power contactor 100 may further comprise a blowing device 110 of an electric arc appearing between each movable contact 104A, 104B and the associated fixed contact 102A, 102B, in particular when the power contactor 100 is opened. The blowing device 110 is designed to displace and extinguish the electric arc. The displacement of the electric arc is obtained, for example, by applying a magnetic field, and its extinction is obtained, for example, by dividing the electric arc into several smaller electric arcs.

The power contactor 100 further comprises an electrically insulating screen 112 associated with a pair of fixed/movable contact (the pair 102A, 104A in the example shown). The screen 112 is designed to move between a spaced apart position, in which the screen 112 allows the movable contact 104A to move, and an interposed position between the fixed contact 102A and the movable contact 104A in its remote position to prevent the movable contact 104A from reaching its position in contact with the fixed contact 102A. The screen 112 is, for example, in the form of a plate, for example perpendicular to the closing direction F. Thus, when the screen 112 is in the spaced apart position, the contacts 102A, 104A can be selectively moved away from each other and brought into contact with each other according to the commands received by the power contactor 100. Furthermore, it is clear that the screen 112 is designed while the movable contact 104A is already in the spaced apart position from the fixed contact 102A following receipt of an opening command, to be moved from its spaced apart position to its interposed position, in order to cut an electric arc that would have appeared between the contacts 102A, 104A spaced apart from each other.

The screen 112 is preferably made of an electrically insulating material with a high CTI (Comparative Tracking Index), for example at least 500 V, for example 600 V, in order to prevent the formation of a carbon path that could reignite the electric arc.

For example, the screen 112 is designed to move in a straight line, for example perpendicular to the closing direction F. To guide the movement of the screen 112, the power contactor 100 comprises, for example, a slide 114 for guiding the screen 112.

The power contactor 100 further comprises a return device 116 designed to push the screen 112 from its spaced apart position to its interposed position. For example, the return device 116 comprises a spring, for example in extension between a fixed point A (for example of the guide 114) and the screen 112. Alternatively, the spring could be in compression.

The power contactor 100 further comprises a fuse 118 forming a mechanical stop for the screen 112, preventing the latter from leaving its spaced apart position, despite the force exerted by the return device 116 on the screen 112. The fuse 118 is designed to trip under the effect of heat generated by an electric arc appearing between the fixed contact 102A and the movable contact 104A. When triggered, the fuse 118 is designed to disintegrate and thus lose its stop function, allowing the screen 112 to leave its spaced apart position and reach its interposed position under the effect of the return device 116. The fuse 118 is, for example, fixed to the fixed busbar 108. Again, for example, the fuse 118 is shaped like a pin rising preferably parallel to the closing direction F. The fuse 118 is made, for example, of a tin alloy. It has a tripping temperature (also called melting temperature) of, for example, between 200° C. and 250° C., for example 230° C.

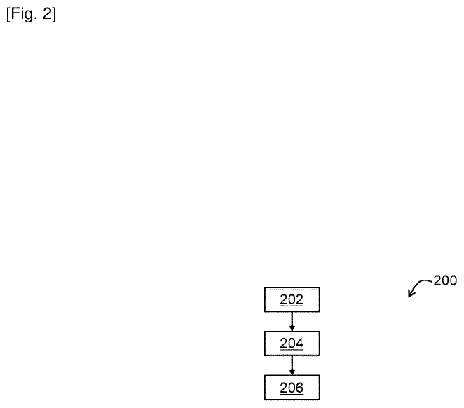

With reference to FIG. 2, an example of a method 200 of operation of the power contactor 100 of FIG. 1 will now be described.

Initially, the power contactor 100 is closed. The movable contacts 104A and 104B are in contact with the fixed contacts 102A and 102B, respectively. Thus, a current flows as follows: through the fixed busbar 108A, then the fixed contact 102A, then the movable contact 104A, then the movable busbar 106, then the movable contact 104B, then the fixed contact 102B, then the fixed busbar 108B.

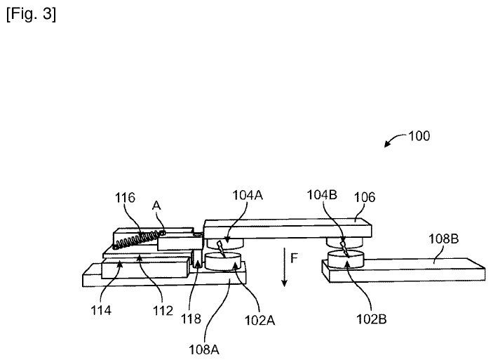

During a step 202, the power contactor is opened. The movable contacts 104A, 104B move away from the fixed contacts 102A, 102B. Electric arcs then appear between the movable contact and the fixed contact of each pair, as shown in FIG. 3. These electric arcs generate heat. In particular, a part of the heat generated by the electric arc between the movable contact 104A and the fixed contact 102A diffuses by conduction into the fixed contact 102A, then into the fixed busbar 108A, until it reaches the fuse 118, which heats up.

During normal operation of the power contactor 100, these arcs should be blown out by the blowing device 110 before the temperature of the fuse reaches its trip threshold.

During a step 204, when the electric arcs persist for too long, for example more than a few tens of milliseconds, for example due to a failure of the blowing device 110, the temperature of the fuse 118 reaches the threshold and the fuse 118 trips and disintegrates. This releases the screen 112.

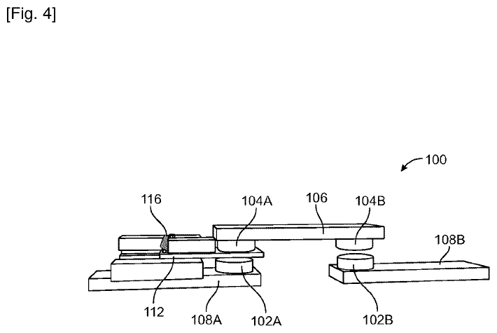

Thus, during a step 206, the return device 116 pushes the screen 112 from its remote position to its interposed position between the movable contact 104A and the fixed contact 102A, as shown in FIG. 4. The sudden elongation of the electric arc due to the screen 112 creates sufficient arc impedance for the counter-electromotive force of the series arc to oppose the mains voltage until the current is cut off.

In conclusion, it should be noted that the invention is not limited to the embodiments described above. In fact, it will be apparent to those skilled in the art that various modifications may be made to the embodiments described above in light of the teaching just disclosed.

In the detailed presentation of the invention as set forth above, the terms used should not be interpreted as limiting the invention to the embodiments disclosed herein, but should be interpreted to include all equivalents within the scope of those skilled in the art applying their general knowledge to the implementation of the teaching disclosed herein.

1. A power contactor comprising:
a fixed contact;
a movable contact designed to move relative to the fixed contact between a position in contact with the fixed contact to allow current to pass and a remote position from the fixed contact to prevent current from passing; and
an electrically insulating screen designed to move between a spaced apart position from and a position interposed between the fixed contact and the movable contact in its remote position;
wherein:
a return device designed to push the screen from its spaced apart position to its interposed position; and
a fuse forming a mechanical stop preventing the screen from leaving its spaced apart position, the fuse being designed to trip in order to allow the screen to leave its spaced apart position to reach its interposed position under the effect of the return device, under the effect of heat generated by an electric arc appearing between the fixed contact and the movable contact.

2. The power contactor according to claim 1, further comprising:
another fixed contact; and
another movable contact designed to move relative to the other fixed contact between a position in contact with the other fixed contact to allow current to pass and a remote position from the other fixed contact to prevent current from passing, the two movable contacts being fixed to each other so as to move at the same time.

3. The power contactor according to claim 1, wherein the screen is in the form of a plate, preferably perpendicular to a closing direction (F) wherein the movable contact moves between its spaced apart position and its interposed position.

4. The power contactor according to claim 1, further comprising a busbar to which the fixed contact is fixed, and wherein the fuse is fixed on the busbar.

5. The power contactor according to claim 1, wherein the fuse is in the form of a pin, preferably rising parallel to the closing direction (F).

6. The power contactor according to claim 1, wherein the return device comprises a spring.

7. The power contactor according to claim 6, wherein the spring is extended between a fixed point (A) and the screen.

8. The power contactor according to claim 1, further comprising a blowing device of an electric arc appearing between the fixed contact and the movable contact.

9. An aircraft comprising a contactor according to claim 1.
